(19) United States
(12) Patent Application Publication
(10) Pub. No.: US 2026/0117015 A1
(43) Pub. Date: Apr. 30, 2026

(54) METHOD OF CURING A POLYTHIOURETHANE BASED SUBSTRATE WITH A SALT CATALYST

(71) Applicant: ESSILOR INTERNATIONAL, Charenton-le-Pont (FR)

(72) Inventors: Jia Mei SOON, Wissous (FR); Pimchaya YUKTANAN, Bangkok (TH)

(21) Appl. No.: 19/118,463

(22) PCT Filed: Oct. 5, 2023
(86) PCT No.: PCT/EP2023/077533

§ 371 Date: Apr. 4, 2025

(30) Foreign Application Priority Data
Oct. 5, 2022 (EP) 22306488.2

(51) Int. Cl. C08G 18/10; C08G 18/22; C08G 18/38; C08G 18/76; G02B 1/04

(52) U.S. Cl. CPC C08G 18/10; C08G 18/225; C08G 18/3876; C08G 18/7642; G02B 1/041

(57) ABSTRACT

The invention relates to a method of curing a polythiourethane based transparent casted substrate, comprising providing a first component A comprising at least one polyisocyanate or polyisothiocyanate monomer A2, providing a second component B comprising a polythiourethane pre-polymer B1 having thiol end groups, mixing together first and second components A and B and filling a molding cavity of a casting mold assembly with the resulting polymerizable mixture, curing said polymerizable mixture to obtain a polythiourethane based transparent substrate, wherein curing step 4) is carried out in the presence of at least one salt catalyst in an amount ranging from 0.015% to 0.15% by weight with respect to the total weight of polymerizable compounds present in the mixture of first and second components A and B. Alternatively, the first component A comprises a polythiourethane pre-polymer A1 having isocyanate or isothiocyanate end groups and the second component B comprises at least one polythiol monomer B2.

The present invention relates to a process for manufacturing polythiourethane-based substrates, and in particular optical substrates such as ophthalmic lenses, having generally a middle or high refractive index, preferably of at least 1.52, more preferably of at least 1.54, more preferably of at least 1.6 and even more preferably of at least 1.67, within short curing cycles.

### BACKGROUND AND SUMMARY OF THE INVENTION

Ophthalmic lenses made of polythiourethane based substrates are typically prepared by a process comprising mixing appropriate monomers in a tank, such as a mixture of a polyisocyanate and a polythiol, adding catalyst and additive, filling a molding cavity with this liquid mixture of monomers, polymerizing the monomer mixture and thereafter recovering the polymerized polythiourethane based substrate from the mold. The mixture is then subjected to a thermal cycle in an oven, for a typical duration of 20 hours.

The application WO 00/26272 discloses a polymerizable composition for making a poly(thio)urethane resin comprising at least one polyiso(thio)cyanate monomer, at least one polythiol monomer and a salt catalyst system, typically a mixture of KSCN and a crown ether.

A fast cure process is highly desirable over usual process as the shorter residence time in curing oven enables a dramatic productivity gain, complex and demanding lens geometries can be obtained in better yield as the final polymerizable mixture shrinkage is lower than that of mixture obtained directly from monomers, compatibility with the adhesive of tape used for mold assembly is better, and energy consumption during polymerization cycles is reduced.

It is known to reduce the time required to cure the polymerizable composition poured into mold assemblies by at least partially replacing monomers with pre-polymers (or oligomers). The monomers are first pre-reacted to form oligomers (pre-polymers), then blended with a catalyst that provides a high overall reactivity in very small volume or even through in-line mixing equipment, then poured into mold assemblies that are subjected to a short polymerization cycle, typically few hours.

In this regard, US 2003/125410 discloses a method of fast curing polythiourethane transparent casted substrate, which comprises the steps of:
1) Providing a first component A comprising a polythiourethane pre-polymer having isocyanate or isothiocyanate end groups,
2) Providing a second component B comprising a polythiourethane pre-polymer having thiol end groups,
3) Mixing together first and second components A and B and filling a molding cavity of a casting mold assembly with the resulting mixture,
4) Curing said mixture to obtain a transparent solid substrate, in the presence of 0.001 to 2.5% by weight, based on the total weight of the polymerizable monomers, of a highly reactive catalyst to dramatically shorten the curing time of the polymerizable composition within typically 2 hours.

US 2007/098999 discloses a similar process involving two pre-polymers.

Provided that the viscosity is controlled, batch mixing of such mixtures is inherently safer than usual process from monomers, as part of the available bond forming energy has already been released during the oligomers formation (pre-polymerization), which limits formation of local heat points in the final polymerizable mixture. The use of pre-polymers allows stable and steady reaction. Known catalysts for polythiourethane synthesis are dibutyltin dichloride or a mixture of KSCN and 18-crown-6.

In applications WO 2021/182526, EP 3916470 and EP 3919967, a different approach for fast curing a polythiourethane optical material has been chosen, combining the use of monomers and pre-polymers in the presence of a polymerization catalyst, typically a basic catalyst such as lutidine.

The choice of catalyst in polythiourethane curing process is very important, as not only does it determine the speed of material curing, in specific cases it might also affect the final optical quality of the material. Oftentimes, a compromise between reaction speed and material quality has to be made, because faster reaction rate could lead to uncontrolled polymerization, and hence higher striations and more bubbles.

An object of the invention is to provide a process of fast making a polythiourethane resin, which remedies the drawbacks of the prior art methods, i.e., allowing a better control of the reaction without increasing the curing time, and avoiding runaway of the reaction. This process should not impair the thermomechanical properties of the final material.

Another object of the invention is to provide a method of curing polythiourethane based casted substrates substantially free from optical defects, in particular free from bubbles and/or striations resulting from the polymerization process, having high transmittance and clarity, as well as low yellowness index and resistant to aging.

The present inventors have found that the replacement of the prior art catalysts with a salt catalyst allowed the use of a higher amount of catalyst together with a better control of the polymerization of a polymerizable mixture comprising a polythiourethane pre-polymer having isocyanate, isothiocyanate or thiol end groups and another monomer.

The present invention provides a method of fast curing a polythiourethane-based transparent casted substrate, usable for making optical articles such as ophthalmic lenses, which comprises the following steps 1), 2), 3), 4) and 5) or 1′), 2′), 3), 4) and 5):
1) Providing a first component A comprising at least one polyisocyanate or polyisothiocyanate monomer A2,
2) Providing a second component B comprising a polythiourethane pre-polymer B1 having thiol end groups, said pre-polymer B1 having been prepared from at least one polythiol monomer and at least one polyisocyanate or polyisothiocyanate monomer,
or:
1′) Providing a first component A comprising a polythiourethane pre-polymer A1 having isocyanate or isothiocyanate end groups of formula —NCX where X is O or S, said pre-polymer A1 having been prepared from at least one polythiol monomer and at least one polyisocyanate or polyisothiocyanate monomer,
2′) Providing a second component B comprising at least one polythiol monomer B2,
3) Mixing together first and second components A and B and filling a molding cavity of a casting mold assembly with the resulting polymerizable mixture,
4) Curing said polymerizable mixture to obtain a polythiourethane based transparent substrate, and
5) Recovering the polythiourethane based transparent substrate from the casting mold assembly,
wherein curing step 4) is carried out in the presence of at least one salt catalyst in an amount ranging from 0.015% to 0.15% by weight with respect to the total weight of polymerizable compounds present in the mixture of first and second components A and B.

### DETAILED DESCRIPTION OF THE INVENTION

The substrate of the invention is an organic glass substrate, made from a thermosetting resin. The polymer matrix of substrate is obtained from a material composition (“substrate composition”) comprising at least one polymerizable pre-polymer, and at least two polymerizable pre-polymer in some embodiments.

The substrate is preferably an optical article substrate, more preferably an optical lens substrate. The optical article is preferably an ophthalmic lens, such as a plastic eyeglass lens.

In the present description, unless otherwise specified, a substrate is understood to be transparent when the observation of an image through said substrate is perceived with no significant loss of contrast, that is, when the formation of an image through said substrate is obtained without adversely affecting the quality of the image. This definition of the term “transparent” can be applied to all objects qualified as such in the description, unless otherwise specified.

The term “ophthalmic lens” is used to mean a lens adapted to a spectacle frame to protect the eye and/or correct the sight. Said lens can be chosen from afocal, unifocal, bifocal, trifocal, progressive lenses and Fresnel lenses or any other kind of lenses having a discontinuous surface.

Although ophthalmic optics is a preferred field of the invention, it will be understood that this invention can be applied to optical elements of other types such as, for example, lenses for optical instruments, filters particularly for photography or astronomy, optical sighting lenses, ocular visors, optics of lighting systems, screens, glazings, etc.

If the optical article is an optical lens, it may be coated on its front main surface, rear main side, or both sides with one or more functional coatings. As used herein, the rear face of the substrate is intended to mean the face which, when using the article, is the nearest from the wearer's eye. It is generally a concave face. On the contrary, the front face of the substrate is the face which, when using the article, is the most distant from the wearer's eye. It is generally a convex face. The optical article can also be a piano article.

A substrate, in the sense of the present invention, should be understood to mean an uncoated substrate, and generally has two main faces. The substrate may in particular be an optically transparent material having the shape of an optical article, for example an ophthalmic lens destined to be mounted in glasses. In this context, the term “substrate” is understood to mean the base constituent material of the optical lens and more particularly of the ophthalmic lens. This material may act as support for a stack of one or more coatings or layers.

The refractive index of the polythiourethane based substrate is preferably 1.52 or greater, more preferably 1.54 or greater, more preferably 1.56 or greater, more preferably 1.58 or greater, more preferably 1.60 or greater, and still more preferably 1.65 or greater or 1.67 or greater, and it is preferably 1.80 or less, more preferably 1.70 or less, and still more preferably 1.67 or less. Unless otherwise specified, the refractive indexes referred to in the present application are expressed at 25° C. at a wavelength of 550 nm.

The fast cure polymerizable composition leading to a polythiourethane based material is composed of two main components.

In a first embodiment of the invention, the first component A provided in step 1) is comprised of at least one polyisocyanate or polyisothiocyanate monomer A2. In step 2) of the first embodiment of present process, a second component B comprising a polythiourethane pre-polymer B1 having thiol end groups is provided and has been prepared from at least one polythiol monomer and at least one polyisocyanate or polyisothiocyanate monomer, the former being used in excess. The second component B comprises therefore oligomers and the initial monomers that did not polymerize, when present.

In a second embodiment of the invention, a first component A comprising a polythiourethane pre-polymer A1 having isocyanate or isothiocyanate end groups is provided in step 1′) and has been prepared from at least one polythiol monomer and at least one polyisocyanate or polyisothiocyanate monomer, the latter being used in excess. The first component A comprises therefore oligomers and the initial monomers that did not polymerize. The second component B provided in step 2′) of the second embodiment of present process is comprised of at least one polythiol monomer B2.

Compared to prior art processes which use only iso(thio)cyanate or thiol monomers, the present invention uses a polythiourethane pre-polymer.

By pre-polymer, it is meant a polymer or oligomer comprising pre-polymer molecules. By pre-polymer molecule, it is meant a macromolecule or oligomer molecule capable of entering, through reactive (polymerizable) groups, into further polymerization, thereby contributing more than one monomeric unit to at least one chain of the final macromolecule. It is generally formed from two or more different monomers.

The polythiourethane pre-polymer A1 having isocyanate or isothiocyanate end groups is prepared by reacting at least one polyisocyanate or polyisothiocyanate monomer and at least one polythiol monomer in a proportion such that the molar ratio of isocyanate or isothiocyanate groups to thiol groups NCX/SH preferably ranges from 3:1 to 30:1, preferably in the absence of a catalyst, X being O or S.

The polythiourethane pre-polymer B1 having thiol end groups is prepared by reacting at least one polyisocyanate or polyisothiocyanate monomer and at least one polythiol monomer in a proportion such that the molar ratio of the thiol groups to the isocyanate or isothiocyanate groups SH/NCX preferably ranges from 3:1 to 30:1, preferably in the absence of a catalyst, X being O or S.

Polythiol and polyisocyanate or polyisothiocyanate compounds used to prepare polythiourethane pre-polymer A1 or B1 are considered herein as monomers, even when they are oligomers.

By polyisocyanate, it is meant any compound comprising at least two isocyanate groups, in other words diisocyanates, triisocyanates, etc. Polyisocyanate pre-polymers may be used. The polyisocyanate may be any suitable polyisocyanate having two or more, preferably two or three isocyanate functions. The polyisocyanate can be used for the preparation of polythiourethane pre-polymers A1 or B1, but also directly in component A in step 1) of the present process.

The polyisocyanates may be selected from aliphatic, aromatic, cycloaliphatic or heterocyclic polyisocyanates and mixtures thereof.

Polyisothiocyanates are defined in the same manner as polyisocyanates above, by replacing the “isocyanate” group by the “isothiocyanate” group.

In one embodiment of the invention, said polyisocyanate or polyisothiocyanate monomer is a compound of formula (VI):

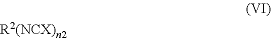

wherein X represents O or S, n2 represents an integer ranging from 2 to 6 and R² represents an aliphatic, alicyclic, heterocyclic or aromatic group.

The preferred polyisocyanate or isothiocyanate monomers are those having the formulae:

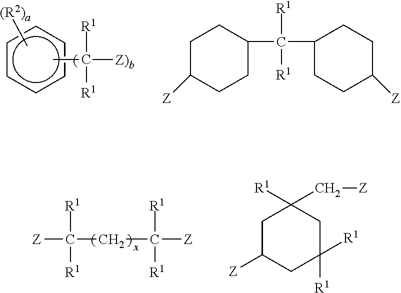

wherein R¹ is independently H or a C₁-C₅ alkyl group, preferably CH₃ or C₂H₅;
R² is H, an halogen, preferably Cl or Br, or a C₁-C₅ alkyl group, preferably CH₃ or C₂H₅;
Z is —N═C═X, with X being O or S, preferably O;
a is an integer ranging from 1 to 4, b is an integer ranging from 2 to 4 and a+b≤6; and
x is an integer from 1 to 10, preferably 1 to 6.

The polyisocyanates of the invention are preferably diisocyanates. Among the available diisocyanates may be cited toluene-2,4-diisocyanate, toluene-2,6-diisocyanate, diphenylmethane-4,4′-diisocyanate, diphenylmethane-2,4′-diisocyanate, paraphenylene diisocyanate, xylylene diisocyanate, biphenyl-diisocyanate, 3,3′-dimethyl-4,4′-diphenylene diisocyanate, tetramethylene-1,4-diisocyanate, hexamethylene-1,6-diisocyanate, 2,2,4-trimethyl hexane-1,6-diisocyanate, lysine methyl ester diisocyanate, bis(isocyanatoethyl) fumarate, isophorone diisocyanate (IPDI), ethylene diisocyanate, dodecane-1,12-diisocyanate, cyclobutane-1,3-diisocyanate, cyclohexane-1,3-diisocyanate, cyclohexane-1,4-diisocyanate, methylcyclohexyl diisocyanate, hexahydrotoluene-2,4-diisocyanate, tetramethylxylylene diisocyanate, hexahydrotoluene-2,6-diisocyanate, hexahydrophenylene-1,3-diisocyanate, hexahydrophenylene-1,4-diisocyanate, perhydro diphenylmethane-2,4′-diisocyanate, perhydro phenylmethane-4,4′-diisocyanate (or bis-(4-isocyanatocyclohexyl)-methane, or 4,4′-dicycdohexyl methanediisocyanate), bis(isocyanatomethyl) cyclohexane, dicyclohexylmethane diisocyanate, 2,5(or 2,6)-bis(isocyanatomethyl)bicyclo-[2.2.1]-heptane, and their mixtures.

Other non-limiting examples of polyisocyanates are the isocyanurates from isophorone diisocyanate and 1,6-hexamethylene diisocyanate, both of which are commercially available. Further polyisocyanates suitable for the present invention are described in detail in WO 98/37115, WO 2014/133111 or EP 1877839.

The polythiols that may be used in the present invention are defined as compounds comprising at least two sulfhydryl (mercapto) groups, in other words dithiols, trithiols, tetrathiols etc. Polythiols pre-polymers may be used. The polythiol may be any suitable polythiol having two or more, preferably two or three thiol functions. The polythiol can be used for the preparation of polythiourethane pre-polymers A1 or B1, but also directly in component B in step 2′) of the present process.

In one embodiment of the invention, said polythiol monomer is a compound of formula:

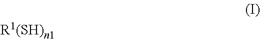

wherein n1 represents an integer ranging from 2 to 6 and R¹ represents an aliphatic, alicyclic, heterocyclic or aromatic group.

Among the preferred polythiol monomers and/or oligomers suitable in accordance with the present invention, there may be cited aliphatic polythiols such as trimethylolpropanetris(2-mercaptoacetate), trimethylolpropanetris(3-mercaptopropionate), trimethylolethanetris(2-mercaptoacetate), trimethylolethanetris(3-mercaptopropionate), pentaerythritol tetrakis(2-mercaptoacetate), pentaerythritol tetrakis(3-mercaptopropionate), bis(mercaptomethyl)sulfide, bis(mercaptomethyl)disulfide, bis(mercaptoethyl)sulfide, bis(mercaptoethyl)disulfide, bis(mercaptopropyl)sulfide, bis(mercaptopropyl)disulfide, 2,3-bis((2-mercaptoethyl)thio)-1-propanethiol, 4,8(or 4,7 or 5,7)-dimercaptomethyl-1,11-dimercapto-3,6,9-trithiaundecane, 2,5-dimercaptomethyl-1,4-dithiane, and 2,5-bis[(2-mercaptoethyl)thiomethyl]-1,4-dithiane, 1-(1′-mercaptoethylthio)-2,3-dimercaptopropane, 1-(2′-mercapropylthio)-2,3-dimercaptopropane, 1-(3′-mercapropylthio)-2,3-dimercaptopropane, 1-(4′-mercabutylthio)-2,3-dimercaptopropane, 1-(5′-mercapentylthio)-2,3-dimercaptopropane, 1-(6′-mercahexylthio)-2,3-dimercaptopropane, 1,2-bis-(4′-mercaptobutylthio)-3-mercaptopropane, 1,2-bis-(5′-mercaptopentylthio)-3-mercaptopropane, 1,2-bis-(6′-mercaptohexylthio)-3-mercaptopropane, 1,2,3-tris(mercaptomethylthio)propane, 1,2,3-tris-(3′-mercaptopropylthio)propane, 1,2,3-tris-(2′-mercaptoethylthio) propane, 1,2,3-tris-(4′-mercaptobutylthio)propane, 1,2,3-tris-(6′-mercaptohexylthio)propane, methanedithiol, 1,2-ethanedithiol, 1,1-propanedithiol, 1,2-propanedithiol, 1,3-propanedithiol, 2,2-propanedithiol, 1,6-hexanethiol-1,2,3-propanetrithiol, and 1,2-bis(2′-mercaptoethylthio)-3-mercaptopropane. Further examples of polythiols are shown in the formulae below or can be found in WO 2014/133111, EP 394495, U.S. Pat. No. 4,775,733 or EP 1877839:

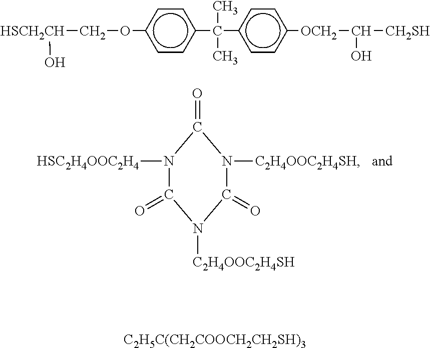

In one embodiment of the invention, said polythiol monomer is selected from the group consisting of pentaerythritol tetrakis(3-mercaptopropionate), pentaerythritol tetrakis(thioglycolate), tris(3-mercaptopropionate) trimethylolpropane, tris(mercaptoacetate) trimethylolpropane and compounds of formulae (II) and (III):

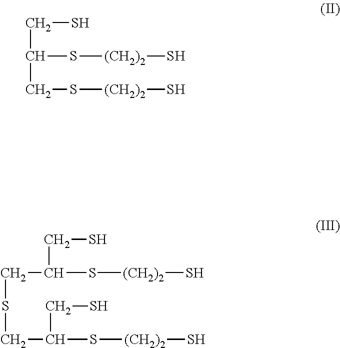

Preferred embodiments are combination of xylylene diisocyanate and pentaerythritol tetrakis(3-mercaptopropionate); combination of xylylene diisocyanate and 2,3-bis((2-mercaptoethyl)thio)-1-propanethiol; combination of 2,5 (or 2,6)-bis(isocyanatomethyl)bicyclo-[2.2.1]-heptane, pentaerythritol tetrakis(3-mercaptopropionate) and 2,3-bis((2-mercaptoethyl)thio)-1-propanethiol; combination of xylylene diisocyanate and 4,8(or 4,7 or 5,7)-dimercaptomethyl-1,11-dimercapto-3,6,9-trithiaundecane; combination of dicyclohexylmethane diisocyanate and 4,8(or 4,7 or 5,7)-dimercaptomethyl-1,11-dimercapto-3,6,9-trithiaundecane; or a combination of bis(2,3-epithiopropyl)disulfide and 4,8(or 4,7 or 5,7)-dimercaptomethyl-1,11-dimercapto-3,6,9-trithiaundecane. The most preferred polythiol is 2,3-bis((2-mercaptoethyl)thio)-1-propanethiol of formula (II).

Preferably the polythiols have a viscosity at 25° C. of 1 Pa·s or less, more preferably 5·10⁻¹ Pa·s or less, more preferably 2.5·10⁻¹ Pa·s or less, more preferably 2·10⁻¹ Pa·s or less, more preferably 10⁻¹ Pa·s or less and even more preferably of 0.5·10⁻¹ Pa·s or less.

Specific examples of polythiourethane resins suitable to the present invention are those marketed by the Mitsui Chemicals company as MR® series, in particular MR6®, MR7® (refractive index: 1.67), MR8® (refractive index: 1.6) resins, MR10® (refractive index: 1.67). These optical materials as well as the monomers used for their preparation are especially described in the U.S. Pat. Nos. 4,689,387, 4,775,733, 5,059,673, 5,087,758 and 5,191,055.

Depending on the embodiment of the invention, components A and B are prepared by polymerizing mixtures of required amounts of at least one polyisocyanate and/or at least one polyisothiocyanate monomer and at least one polythiol monomer, and optionally polyols monomers or polyamines monomers. Typically, components A and B can be prepared through classical thermal polymerization including induction and infrared heating or UV irradiation.

The amounts of polyisocyanate or polyisothiocyanate monomers and polythiol monomers in the reaction medium are preferably adapted in each case in such a way that the molar ratio of NCX/SH groups for the mixture of polyisocyanate or polyisothiocyanate monomers and polythiol monomers ranges from 3:1 to 30:1 for the preparation of polythiourethane pre-polymer A1, preferably from 6:1 to 10:1, and/or the molar ratio of SH/NCX groups for the mixture of polyisocyanate or polyisothiocyanate monomers and polythiol monomers ranges from 3:1 to 30:1 for the preparation of polythiourethane pre-polymer B1, preferably from 6:1 to 10:1, X being O or S.

In one embodiment, both components A and B are prepared without the use of a catalyst system, which allows better control of the polymerization reaction and results in pre-polymers of high stability in time. However, they can also be prepared using a salt catalyst as described below or another catalyst as described below.

Generally, in the first embodiment of the invention, the at least one polyisocyanate or polyisothiocyanate monomer A2 of component A and the pre-polymer B1 are comprised in the mixture in an amount such that the molar ratio of NCX to SH groups is from 0.8 to 1.2, preferably 1.

Generally, in the second embodiment of the invention, the pre-polymer A1 and the at least one polythiol monomer B2 of component B are comprised in the mixture in an amount such that the molar ratio of NCX to SH groups is from 0.8 to 1.2, preferably 1.

Preparation of pre-polymer B1 having thiol end groups has already been described in U.S. Pat. No. 5,908,876. Similar process can be used to prepare component B of the present invention.

When component A of the present invention comprises polythiourethane pre-polymer A1, it can be prepared in a similar manner but with the required ratio of polyisocyanate or polyisothiocyanate and polythiol monomers in order to obtain polythiourethane pre-polymer A1 having isocyanate or isothiocyanate end groups.

The mixture polythiol/polyiso(thio)cyanate from which pre-polymer A1 is obtained may comprise 90% or less by weight of at least one polyol. Preferably, said mixture may comprise 80% or less, 70% or less, 60% or less, 50% or less, 40% or less, 30% or less, 20% or less, 10% or less by weight of at least one polyol. Also preferably, no polyol is used. Polyiso(thio)cyanate means polyisocyanate or polyisothiocyanate.

The mixture polythiol/polyiso(thio)cyanate from which pre-polymer B1 is obtained may comprise 90% or less by weight of at least one polyol. Preferably, said mixture may comprise 80% or less, 70% or less, 60% or less, 50% or less, 40% or less, 30% or less, 20% or less, 10% or less by weight of at least one polyol. Also preferably, no polyol is used.

The mixture of components A and B according to the invention may also include additives which are conventionally employed in polymerizable compositions intended for molding optical articles, in particular ophthalmic lenses, in conventional proportions, namely inhibitors, dyes, photochromic agents, UV absorbers, perfumes, deodorants, antioxidants, resin modifiers, color balancing agents, chain extenders, crosslinking agents, free radical scavengers such as antioxidants or hindered amine light stabilizers (HALS), dyes, pigments, fillers, adhesion accelerators, anti-yellowing agents and mold release agents.

In one embodiment, the additives are added to first component A prior to the mixing with second component B.

UV absorbers are frequently incorporated into optical articles in order to reduce or prevent UV light from reaching the retina (in particular in ophthalmic lens materials). The UV absorber that may be used in the present invention preferably have the ability to at least partially block light having a wavelength shorter than 400 nm, but can also have an absorption spectrum extending to the visible blue light range of the electromagnetic spectrum (400-450 nm), in particular 420-450 nm.

Said UV absorbers both protect the user's eye from UV light and the substrate material itself, thus preventing it from weathering and becoming brittle and/or yellow. The UV absorber according to the invention can be, without limitation, a benzophenone-based compound, a benzotriazole-based compound or a dibenzoylmethane-based compound, preferably a benzotriazole compound. Suitable UV absorbers include without limitation 2-(2-hydroxyphenyl)-benzotriazoles such as 2-(2-hydroxy-3-tert-butyl-5-methylphenyl)-5-chlorobenzotriazole (Seesorb® 703/Tinuvin® 326), or other allyl hydroxymethylphenyl chlorobenzotriazoles, 2-(5-chloro-2H-benzotriazol-2-yl)-6-(1,1-dimethylethyl)-4-methylphenol (Viosorb® 550), n-octyl-3-[3-tert-butyl-4-hydroxy-5-(5-chloro-2H-benzotriazol-2-yl)phenyl]propionate (Eversorb® 109), 2-(2-hydroxy-5-methoxyphenyl)benzotriazole, 2-(2-hydroxy-5-butoxyphenyl)benzotriazole and also Tinuvin® CarboProtect® from BASF. Preferred absorbers are of the benzotriazole family. Other examples of benzotriazole UV absorbers protecting from blue light can be found in WO 2017/137372.

The amount of UV absorber compounds according to the invention used herein is an amount sufficient to provide a satisfactory protection from UV light but not excessive so as to prevent precipitation. The inventive UV absorber compounds are generally present in an amount ranging from 0.05 to 4% by weight relative to the optical material total weight (or per 100 parts by weight of the polymerizable compounds present in the mixture of components A and B or relative to the weight of the optical material composition), preferably from 0.1 to 3% by weight, more preferably from 0.1 to 2% by weight.

Among the release agents that may be used in the invention, there may be cited mono and dialkyl phosphates, alkyl ester phosphates, silicones, fluorinated hydrocarbon, fatty acids and ammonium salts. The preferred release agents are mono and dialkyl phosphates, alkyl ester phosphates and mixtures thereof. Such release agents are disclosed inter alia in U.S. Pat. No. 4,975,328 and EP 271839. The release agent is preferably used in an amount lower than or equal to 1% by weight based on the total weight of the polymerizable compounds present in the mixture of components A and B.

The polymerizable mixture of the present invention can comprise a solvent for promoting the dissolution of the salt catalyst. In one embodiment, curing step 4) is carried out in the presence of at least one solvent of the salt catalyst, preferably 2-mercaptoethanol.

Any polar organic solvent can be used such as acetonitrile, tetrahydrofuran, dioxane, ethanol, 2-mercaptoethanol, acetone, and 3-methyl-2-butene-1-ol. The amount of solvent is generally kept below 2% by weight, based on the total weight of the polymerizable compounds present in the mixture of components A and B and preferably from 0 to 0.5% by weight, to avoid haze and bubbling. In one embodiment, the catalyst is used under the form of a solution in a compound such as 2-mercaptoethanol.

In the present invention, at least one salt catalyst can be used in the process prior to curing step 4). In one embodiment, the resulting mixture of step 3) comprises at least one salt catalyst.

The salt catalyst is a system for accelerating the polymerization reaction. The salt catalyst shall be used in the polymerizable composition in an amount sufficient to promote the polymerization of the mixture, i.e., in an amount ranging from 0.015% to 0.15% by weight with respect to the total weight of polymerizable compounds present in the mixture of first and second components A and B, preferably from 0.0425% to 0.102% by weight.

A too low amount of catalyst should be avoided to prevent the generation of bubbles, in particular when a pre-polymer B1 is combined with a polyisocyanate or polyisothiocyanate monomer A2, which may be due to heat convection generated during polymerization.

A too high amount of catalyst should also be avoided to prevent premature gelation of the polymerizable mixture before it is introduced in the mold, in particular when a pre-polymer A1 is combined with a polythiol monomer B2.

In the first embodiment of the present process, where the first component A is comprised of at least one polyisocyanate or polyisothiocyanate monomer A2 and the second component B comprises a polythiourethane pre-polymer B1 having thiol end groups, said at least one salt catalyst is preferably present in an amount ranging from 0.03% to 0.15% or 0.034% to 0.102%, more preferably from 0.0595% to 0.102% by weight with respect to the total weight of polymerizable compounds present in the mixture of first and second components A and B. In one embodiment, said amount ranges from 0.0595% to 0.15% by weight with respect to the total weight of polymerizable compounds present in the mixture of first and second components A and B.

In the second embodiment of the present process, where the first component A is comprised of a polythiourethane pre-polymer A1 having isocyanate or isothiocyanate end groups and the second component B is comprised of at least one polythiol monomer B2, said at least one salt catalyst is preferably present in an amount ranging from 0.015% to 0.0765%, more preferably from 0.017% to 0.068%, even more preferably from 0.0425% to 0.068%, by weight with respect to the total weight of polymerizable compounds present in the mixture of first and second components A and B.

The use of the present salt catalyst is advantageous, as other catalysts used in similar amounts as in the present process, such as amines (for example lutidine) or tin-based catalyst, lead to runaway reactions, undesirable premature gelling of the polymerizable mixture and/or materials with inferior optical and thermomechanical properties. The salt catalysts according to the invention allow a better control of the reaction without increasing the curing time, since they can be used in a higher amount without runaway of the reaction of premature gelling.

The salt catalyst can be added at different stages of the present process.

In one embodiment, the salt catalyst is added to the polythiol monomers B2 during the preparation of component B, or to the polythiourethane pre-polymer B1 having thiol end groups, depending on the case. In other words, at least one salt catalyst is added to said second component B prior to step 4). In another embodiment, at least one salt catalyst is added to said first component A prior to step 4).

In one embodiment, the salt catalyst is added to the first component A obtained in step 1) or 1′) prior to mixture with component B or to the second component B obtained in step 2) or 2′) prior to mixture with component A. In this embodiment, the salt catalyst can be added to pre-polymers A1 and/or B1 after their preparation, depending on the case.

In another preferred embodiment, the salt catalyst is added to the mixture of components A and B in step 3) of the present process.

In one embodiment, the salt catalyst is a salt compound of formula Mₘ^{p}+Yₙ^{q-},
wherein M^{p+} is a cation of valence p selected from the group consisting of alkaline metal cations, alkaline earth metal cations, transition metal cations and ammonium groups of formula NR₄⁺ in which R is an alkyl group having preferably from 1 to 10 carbon atoms, Y^{q-} is an anion, m, n, p and q being integers such that n×q=m×p; preferably q=1. Preferably, Y^{q-} is such that the corresponding acid YH^{(q-1)-} has a pKa fulfilling the condition 0.5≤pKa≤14.

In the present application, pKa is preferably expressed at 25° C. pKa can be measured in water at standard pressure by potentiometric (pH) titration, using a glass electrode and a pH meter.

The preferred metallic cations of the salts are Li⁺, Na⁺, K⁺, Cs⁺, Mg²⁺, Ca²⁺, Mn²⁺, Ag⁺, Ba²⁺ and Al³⁺. The particularly preferred metallic cations are Li⁺, Na⁺ and K⁺ due to their absence of color and solubility in the composition. Transition metals are less preferred because their salts can lead to colored compositions and therefore colored polymerized resins. In one embodiment, the method according to the invention does not use a catalyst containing tin.

The preferred NR⁺₄ groups are those in which R is a C₁-C₈ alkyl group and more preferably, a methyl, ethyl, propyl, butyl or hexyl group.

Preferably, Y^{q-} is an anion such that the corresponding acid YH^{(q-1)-} fulfills the condition 0.5≤pKa≤10 and more preferably 0.5≤pKa≤8.

Preferably, the anion Y^{q-} is selected from the group consisting of thiocyanate, carboxylate anions, thiocarboxylate anions, acetylacetonate, diketone anions, acetoacetic ester anions, malonic ester anions, cyanoacetic ester anions, ketonitrile anions, malononitrile anion and anions of formula RS⁻ wherein R is a substituted or non-substituted alkyl group having preferably from 1 to 10 carbon atoms or an aryl group having preferably from 6 to 12 carbon atoms.

The preferred anions Y^{q-} are SCN⁻, acetylacetonate, acetate, thioacetate, formate and benzoate. The preferred salt catalyst is KSCN.

Among additional catalysts that can be used in the method of the invention, there may also be cited amines, such as tertiary amines (e.g., triethylamine or 3,5-lutidine), organometallic compounds, such as alkyltins or alkyltin oxides, in particular dibutyltin dilaurate, dibutyltin dichloride and dimethyltin dichloride. Several catalysts can be combined in the present process.

In a preferred embodiment, the method according to the invention does not use any catalyst that is not a salt catalyst.

Electron-donor compounds may also be used in combination with the salt catalyst, especially when the polymerizable composition comprises poorly reactive thiols and/or iso(thio)cyanates. Generally, electron-donor compounds stabilize the cation of the salt catalyst. They thus contribute to dissociate the anion/cation ion pair and thus do increase the anion reactivity in the polymerizing medium, and therefore promote the polymerization reaction.

Electron-donor compounds are preferably selected from acetonitrile compounds such as malononitriles, amides, amines, imines, phosphines, sulfones, sulfoxides, trialkyl phosphites, triaryl phosphites, ethylene glycol ethers, crown ethers and cryptands. Preferred electron-donor compounds are crown ethers, cryptands, trialkyl phosphites, triaryl phosphites, alkylene glycols and alkylene glycol ethers, the most preferred one being 18-crown-6.

In one embodiment, curing step 4) is carried out in the presence of at least one electron-donor compound.

Examples of acetonitrile compounds are:

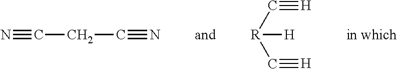

R is an alkyl group, preferably a C₁-C₆ alkyl group such as methyl, ethyl, propyl, butyl.

The amide compounds may be primary, secondary or tertiary amide compounds. The trialkylphosphites and triarylphosphites may be represented by formula:

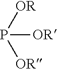

in which R, R′, R″′ are either an alkyl group, preferably a C1-C6 alkyl group or an aryl group having preferably 6 to 12 carbon atoms such as a phenyl group. Preferred are trialkylphosphites, for example (C₂H₅O)₃P.

Electron-donor compounds may also be selected from crown ethers and cryptands.

These cyclic molecules are usually chosen to exhibit a good compromise between the heteroatom or metal size and the “cage” size, i.e., between the number of heteroatoms and the size and the “cage” size, i.e., between the number of heteroatoms and the size of the cycle.

The preferred crown ethers and cryptands may be represented by the following formulae:

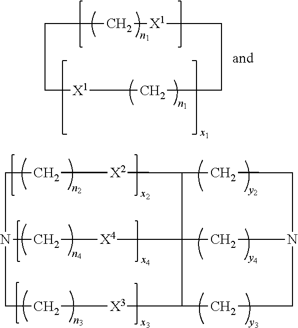

wherein X¹ represents O, S or NH, x₁ is an integer from 3 to 6, preferably from 3 to 4, n₁ is 2 or 3,
X², X³ and X⁴ represent O, S, n₂, n₃, n₄, y₂, y₃, y₄ are 2 or 3 and x₂, x₃, x₄, are 2 or 3.

Among the preferred crown ethers and cryptands there may be cited the following compounds:

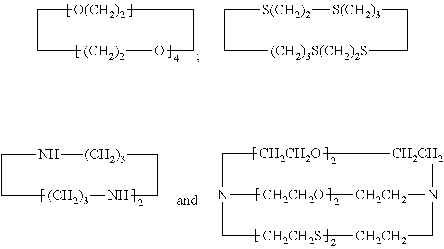

Examples of preferred crown ethers are 18-crown-6, 18-crown-7, 15-crown-5 and 15-crown-6.

The electron-donor compounds are preferably present in an amount ranging from 0 to 5% by weight, preferably 0 to 1% by weight, more preferably from 0.06% to 0.6% by weight, even more preferably from 0.17% to 0.408% by weight, with respect to the total weight of polymerizable compounds present in the mixture of components A and B.

The weight ratio of salt catalyst/electron-donor compound, when the latter is present, preferably ranges from 1/3 to 1/5.

The mixing of first component A with second component B in step 3) can be performed by any known mixing technique such as those mentioned in U.S. Pat. No. 5,973,098. Preferably, components A and B to be mixed are added in a small reactor chamber and then mixed with a screw mixer. In one embodiment, the viscosity at 25° C. of the mixture of components A and B ranges from 0.01 Pa·s to 5 Pa·s, preferably from 0.05 Pa·s to 0.5 Pa·s, even more preferably from 0.1 Pa·s to 0.3 Pa·s.

During step 3), a molding cavity of a casting mold assembly is filled with the mixture of first and second components A and B.

The casting mold assembly generally comprises two mold parts defining two molding surfaces that cooperate to form a molding cavity when moved from an open position to a closed position. Each of the molding surfaces can be concave, convex, or planar, depending on the desired article shape. The molding surface can be convex, e.g., to form a concave substrate surface, or concave, e.g., to form a convex substrate surface.

More specifically, the optical material composition can be poured into the cavity of two mold parts held together using an annular closure such as a gasket or an adhesive tape.

An annular closure member can be disposed around the periphery of the two mold pieces and attached to them. The conventional way to fill such a two-piece mold is by causing the (liquid) optical material composition to flow into the molding cavity through a casting opening provided for this purpose in the closure member. In at least a partly automated process, the molding cavity to be filled is vertically aligned with a filling device that is adapted to deliver a particular quantity of molding material through a nozzle.

Depending on the desired characteristics of the resulting optical material, degassing can be performed under reduced pressure and/or filtration can be performed under increased pressure or reduced pressure before pouring the optical material composition in the mold assembly. After pouring the composition, the casting mold assembly, preferably a lens casting mold assembly, can be heated in an oven or a heating device immersed in water according to a predetermined temperature program to cure the resin in the mold assembly. The resin molded product may be annealed if necessary.

The curing step 4) of the mixture, which provides a polythiourethane-based transparent substrate, is performed in the presence of at least one salt catalyst, and can be implemented using any well known polymerization technique and in particular thermal polymerization including induction and infrared heating, or radiation polymerization. The curing time of step 4) is preferably lower than 10 or 5 hours, more preferably lower than 4, 3 or 2 hours.

In step 5) of the present process, the polythiourethane-based transparent substrate is recovered from the mold.

The present process can be used to manufacture a finished lens, having both sides at the required geometries, or a semi-finished lens, having one face that still needs to be surfaced at the required geometry.

The article resulting from the present process has satisfactory color properties, which can be quantified by the yellowness index Yi. The degree of whiteness of the inventive optical material may be quantified by means of colorimetric measurements, based on the CIE tristimulus values X, Y, Z such as described in the standard ASTM E313 with illuminant C observer 2°. The optical article according to the invention preferably has a low yellowness index Yi, i.e., lower than 10, more preferably lower than 8, even better lower than 6, as measured according to the above standard. The yellowness index Yi is calculated per ASTM method E313 through the relation Yi=(127.69 X−105.92 Z))/Y, where X, Y, and Z are the CIE tristimulus values.

The substrate according to the invention preferably has a colorimetric coefficient b* (in transmission) as defined in the CIE (1976) L*a*b* international colorimetric lower than or equal to 10, 5, 4, 2 or 1, and in a general manner higher or equal to 0. A low colorimetric coefficient b* can be correlated with a limited or non-yellow appearance (transmission color). Indeed, positive values on the b* axis indicate amounts of yellow, while negative values indicate amounts of blue.

The following examples illustrate the present invention in a more detailed, but non-limiting manner. Unless stated otherwise, all thicknesses disclosed in the present application relate to physical thicknesses.

### EXAMPLES

### Chemicals Used

Optical materials were prepared from a composition comprising polymerizable monomers, Zelec UN® (CAS 3896-11-5) as a mold release agent and a catalyst solution comprising KSCN (CAS 333-20-0), 18-crown-6 (CAS 17455-13-9) and mercaptoethanol (CAS 60-24-2). The monomers used in the present examples were xylylene diisocyanate (CAS 3634-83-1) and 2,3-bis((2-mercaptoethyl)thio)-1-propanethiol (CAS 131538-00-6), in order to produce a polythiourethane transparent matrix having a refractive index of 1.67. The monomers were used as received without treatment for eliminating moisture.

In comparative examples 3 to 10, dimethyltin dichloride was used as a comparative catalyst.

Evaluation of the Lenses after Curing

The following test procedures were used to evaluate the optical articles prepared according to the present invention. Several samples for each system were prepared for measurements and the reported data were calculated with the average of the different samples.

The critical temperature of the article was measured 24 hours after its preparation, in the way indicated in the application WO 2008/001011 for the measurement of the critical temperature, except that the relative humidity was not 50% but >90%, typically 100%.

The mechanical properties of the lenses have been evaluated by DMA (dynamic mechanical analysis). The modulus of elasticity E (or Young's modulus, or storage modulus, or tensile modulus of elasticity) makes it possible to evaluate the ability of the material to deform under the effect of a force applied.

### Examples 1-13, Comparative Examples 1-10

### Preparation of Polythiourethane Pre-Polymer A1 Having Isocyanate End Groups

In a reactor equipped with a thermal probe and an agitator, a determined amount of the polyisocyanate monomer m-xylylene diisocyanate (XDI) was charged and heated up to 120° C. Then, 2,3-bis((2-mercaptoethyl)thio)-1-propanethiol was introduced and mixed with the polyisocyanate in an amount such that the molar ratio of the isocyanate functions to the thiol functions NCO/SH was 8:1 (89.7% polyisocyanate, 10.3% polythiol). The mixture was heated for 3.5 hours at 120° C. The resulting pre-polymer A1 was then cooled to around 35° C. and transferred into an appropriate drum and stored in a cold room. Pre-polymer A1 was prepared without the use of catalyst.

### Preparation of Polythiourethane Pre-Polymer B1 Having Thiol End Groups

In a reactor equipped a thermal probe and an agitator, a determined amount of the polythiol monomer 2,3-bis((2-mercaptoethyl)thio)-1-propanethiol was charged and heated up to 95° C. Then, xylylene diisocyanate was introduced and mixed with the polythiol in an amount such that the final molar ratio of the thiol functions to the isocyanate functions SH/NCO was 8:1. The mixture was heated for 3.5 hours at 95° C. The resulting pre-polymer B1 was then cooled to around 35° C. and transferred into an appropriate drum and stored in a cold room. Pre-polymer B1 was prepared without the use of catalyst.

### Preparation of Polythiourethane Transparent Casted Substrates

Convex and concave molds were assembled by using a tape. Center thickness was 2 mm. Pre-polymers A1 and B1 were prepared as described above.

In examples 1-7, a determined amount of cooled down pre-polymer A1 was mixed with a determined amount of Zelec UN®. This mixture was stirred at 15° C. and degassed for 1 hour, degassed for 15 minutes without stirring, to form component A. In parallel, a determined amount of polythiol monomer 2,3-bis((2-mercaptoethyl)thio)-1-propanethiol B2 was mixed with 0.2-0.8% by weight of the above-mentioned catalyst solution (8.5% KSCN, 34.84% 18-crown-6, 56.66% 2-mercaptoethanol, by weight). This mixture was stirred at 15° C. and degassed for 1 hour, degassed for 15 minutes without stirring, to form component B.

Components A and B were then mixed with the molar ratio of SH:NCO adjusted to 1:1 in a small reactor while stirring and degassing for 5 minutes at 15° C. and then further degassing without stirring for 2 minutes at 15° C. to prevent gelation. Once the mixing was complete, the mold assemblies were filled with the help of a syringe and filter.

The assembled molds were held at room temperature for 10 minutes before inserting them in a convection oven preheated at 120° C. The mixture started gelation in the mold assemblies at room temperature. The polymerization reaction was carried out by letting the mold assemblies in the oven for 3 hours at 120° C. Then, they were let to cool down to 65° C.

In the context of the present invention, a gel designates the reaction product of components A and B in which the conversion rate of the reactive functions is significantly high. For example, said conversion rate ranges from 50 to 80% and preferably is about 70%.

The mold assemblies were then disassembled to obtain lenses with 2 mm center thickness comprising a body of polythiourethane transparent thermoset substrate, which were annealed at 120° C. for 1 h after disassembly. The lenses had a refractive index of 1.67 and no optical defects such as striations.

Comparative examples 3-6 were conducted similarly to examples 1-7, except that the catalyst dimethyltin dichloride was used instead of KSCN.

In examples 8-13, the protocol was identical, except that a determined amount of polyisocyanate monomer m-xylylene diisocyanate A2 was mixed with a determined amount of Zelec UN®. This mixture was stirred at 15° C. and degassed for 1 hour, degassed for 15 minutes without stirring, to form component A. In parallel, a determined amount of pre-polymer B1 was mixed with 0.4-1.2% by weight of the above-mentioned catalyst solution (8.5% KSCN, 34.84% 18-crown-6, 56.66% 2-mercaptoethanol, by weight). This mixture was stirred at 15° C. and degassed for 1 hour, degassed for 15 minutes without stirring, to form component B.

Comparative examples 7-10 were conducted similarly to examples 8-13, except that the catalyst dimethyltin dichloride was used instead of KSCN.

In comparative examples 1-2, the protocol was identical, except that a determined amount of polyisocyanate monomer m-xylylene diisocyanate A2 was mixed with a determined amount of Zelec UN®. This mixture was stirred at 15° C. and degassed for 1 hour, degassed for 15 minutes without stirring, to form component A. In parallel, a determined amount of polythiol monomer 2,3-bis((2-mercaptoethyl)thio)-1-propanethiol B2 was mixed with 0.3-0.4% by weight of the above-mentioned catalyst solution (8.5% KSCN, 34.84% 18-crown-6, 56.66% 2-mercaptoethanol, by weight). This mixture was stirred at 15° C. and degassed for 1 hour, degassed for 15 minutes without stirring, to form component B.

### Compositions and Results

The amounts of catalyst used and results of the characterizations are shown in table 1. The castings have been repeated and the data is the average of at least 3 trials.

TABLE 1

| | | | | Storage | |
|---|---|---|---|---|---|
| | | | Catalyst | Modulus | Tg |
| Example | Type | Catalyst | (%) | (GPa) | (° C.) |
| Example 1 | pre-polymer A1 + | KSCN | 0.017 | 3.9 | 82 |
| | monomer B2 | | | | |
| Example 2 | pre-polymer A1 + | KSCN | 0.0255 | 3.8 | 81 |
| | monomer B2 | | | | |
| Example 3 | pre-polymer A1 + | KSCN | 0.034 | 3.8 | 82 |
| | monomer B2 | | | | |
| Example 4 | pre-polymer A1 + | KSCN | 0.0425 | 3.9 | 83 |
| | monomer B2 | | | | |
| Example 5 | pre-polymer A1 + | KSCN | 0.051 | 4.1 | 84 |
| | monomer B2 | | | | |
| Example 6 | pre-polymer A1 + | KSCN | 0.0595 | 3.9 | 82 |
| | monomer B2 | | | | |
| Example 7 | pre-polymer A1 + | KSCN | 0.068 | 3.9 | 83 |
| | monomer B2 | | | | |
| Example 8 | monomer A2 + pre- | KSCN | 0.034 | 3.8 | 82 |
| | polymer B1 | | | | |
| Example 9 | monomer A2 + pre- | KSCN | 0.051 | 3.9 | 82 |
| | polymer B1 | | | | |
| Example 10 | monomer A2 + pre- | KSCN | 0.0595 | 4.0 | 84 |
| | polymer B1 | | | | |
| Example 11 | monomer A2 + pre- | KSCN | 0.068 | 3.8 | 83 |
| | polymer B1 | | | | |
| Example 12 | monomer A2 + pre- | KSCN | 0.085 | 4.2 | 84 |
| | polymer B1 | | | | |
| Example 13 | monomer A2 + pre- | KSCN | 0.102 | 3.9 | 85 |
| | polymer B1 | | | | |
| Comparative 1 | monomer A2 + | KSCN | 0.0255 | 3.7 | 81 |
| | monomer B2 | | | | |
| Comparative 2 | monomer A2 + | KSCN | 0.034 | 3.9 | 80 |
| | monomer B2 | | | | |
| Comparative 3 | pre-polymer A1 + | Dimethyltin | 0.068 | Gelled | Gelled |
| | monomer B2 | dichloride | | | |
| Comparative 4 | pre-polymer A1 + | Dimethyltin | 0.102 | Gelled | Gelled |
| | monomer B2 | dichloride | | | |
| Comparative 5 | pre-polymer A1 + | Dimethyltin | 0.2 | Gelled | Gelled |
| | monomer B2 | dichloride | | | |
| Comparative 6 | pre-polymer A1 + | Dimethyltin | 0.3 | Gelled | Gelled |
| | monomer B2 | dichloride | | | |
| Comparative 7 | monomer A2 + pre- | Dimethyltin | 0.068 | Gelled | Gelled |
| | polymer B1 | dichloride | | | |
| Comparative 8 | monomer A2 + pre- | Dimethyltin | 0.102 | Gelled | Gelled |
| | polymer B1 | dichloride | | | |
| Comparative 9 | monomer A2 + pre- | Dimethyltin | 0.2 | Gelled | Gelled |
| | polymer B1 | dichloride | | | |
| Comparative 10 | monomer A2 + pre- | Dimethyltin | 0.3 | Gelled | Gelled |
| | polymer B1 | dichloride | | | |

Lenses without any optical defect were obtained after a perfectly controlled polymerization reaction.

It can be observed that increasing the catalyst concentration tends to increase the glass transition temperature of the resulting lens.

Results from dynamic mechanical analysis and differential scanning calorimetry show that the storage modulus (E) and the glass transition temperature (Tg) of the products were essentially not affected by changing the process from a polyisocyanate or polyisothiocyanate monomer A2 combined with a polythiourethane pre-polymer B1 having thiol end groups, to a process combining a polythiourethane pre-polymer A1 having isocyanate or isothiocyanate end groups with a polythiol monomer B2.

Advantageously, no bubble issues were observed in pre-polymer systems according to the invention.

In comparative examples 3 to 10, where the catalyst dimethyltin dichloride was used instead of KSCN, undesirable premature gelation occurred and the mixtures were solidified during mixing, before filling or when filling into the mold, at similar catalyst content. Thus, measuring thermomechanical properties was not possible. In examples 1-13, the mixtures have not started gelling before transferring into the mold, indicating that at the same catalyst concentration, the use of the present salt catalyst is advantageous over the use of other catalysts such as tin-based catalysts.

1.-15. (canceled)

16. A method of curing a polythiourethane based transparent casted optical lens substrate, comprising the following steps 1), 2), 3), 4) and 5) or 1′), 2′), 3), 4) and 5):
1) providing a first component A comprising at least one polyisocyanate or polyisothiocyanate monomer A2;
2) providing a second component B comprising a polythiourethane pre-polymer B1 having thiol end groups, said pre-polymer B1 having been prepared from at least one polythiol monomer and at least one polyisocyanate or polyisothiocyanate monomer;
or:
1′) providing a first component A comprising a polythiourethane pre-polymer A1 having isocyanate or isothiocyanate end groups of formula —NCX where X is O or S, said pre-polymer A1 having been prepared from at least one polythiol monomer and at least one polyisocyanate or polyisothiocyanate monomer;
2′) providing a second component B comprising at least one polythiol monomer B2;
3) mixing together first and second components A and B and filling a molding cavity of a casting mold assembly with the resulting polymerizable mixture;
4) curing said polymerizable mixture to obtain a polythiourethane based transparent substrate; and
5) recovering the polythiourethane based transparent substrate from the casting mold assembly;
wherein curing step 4) is carried out in the presence of at least one salt catalyst in an amount ranging from 0.015% to 0.15% by weight with respect to the total weight of polymerizable compounds present in the mixture of first and second components A and B.

17. The method of claim 16, wherein said salt catalyst is a salt compound of formula
$${M}_{m}^{P +} {Y}_{n}^{q -} ,$$
wherein M^{p+} is a cation of valence p selected from the group consisting of alkaline metal cations, alkaline earth metal cations, transition metal cations and ammonium groups of formula NR₄⁺ in which R is an alkyl group, Y^{q-} is an anion, m, n, p and q being integers such that n×q=m×p.

18. The method of claim 17, wherein Y^{q-} is an anion such that the corresponding acid YH^{(q-1)-} has a pKa fulfilling the condition 0.5≤pKa≤14.

19. The method of claim 17, wherein q=1.

20. The method of claim 17, wherein said cation M^{p+} is selected from the group consisting of Li⁺, Na⁺, K⁺, Cs⁺, Mg²⁺, Ca²⁺, Mn²⁺, Ag⁺, Ba²⁺ and Al³⁺.

21. The method of claim 17, wherein R is an alkyl group having from 1 to 10 carbon atoms.

22. The method of claim 17, wherein said anion Y^{q-} is selected from the group consisting of thiocyanate, carboxylate anions, thiocarboxylate anions, acetylacetonate, diketone anions, acetoacetic ester anions, malonic ester anions, cyanoacetic ester anions, ketonitrile anions, malononitrile anion and anions of formula RS⁻ wherein R is a substituted or non-substituted alkyl group or an aryl group.

23. The method of claim 16, wherein said salt catalyst is KSCN.

24. The method of claim 16, wherein said at least one salt catalyst is present in an amount ranging from 0.0425% to 0.102% by weight with respect to the total weight of polymerizable compounds present in the mixture of first and second components A and B.

25. The method of claim 16, wherein curing step 4) is carried out in the presence of at least one electron-donor compound selected from the group consisting of trialkyl phosphites, triaryl phosphites, alkylene glycols, alkylene glycol ethers, crown ethers and cryptands.

26. The method of claim 16, wherein curing step 4) is carried out in the presence of at least one electron-donor compound, which is the cryptand 18-crown-6.

27. The method of claim 16, wherein curing step 4) is carried out in the presence of at least one solvent of the salt catalyst.

28. The method of claim 16, wherein the curing time of step 4) is lower than 10 hours.

29. The method of claim 16, wherein the curing time of step 4) is lower than 5 hours.

30. The method of claim 16, wherein the amounts of polyisocyanate or polyisothiocyanate monomers and polythiol monomers are adapted so that the molar ratio of NCX/SH groups for the mixture of polyisocyanate or polyisothiocyanate monomers and polythiol monomers ranges from 3:1 to 30:1 for the preparation of polythiourethane pre-polymer A1 and/or the molar ratio of SH/NCX groups for the mixture of polyisocyanate or polyisothiocyanate monomers and polythiol monomers ranges from 3:1 to 30:1 for the preparation of polythiourethane pre-polymer B1, X being O or S.

31. The method of claim 16, wherein said polythiol monomer is a compound of formula: 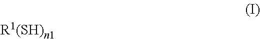
wherein n1 represents an integer ranging from 2 to 6 and R¹ represents an aliphatic, alicyclic, heterocyclic or aromatic group.

32. The method of claim 16, wherein said polythiol monomer is selected from the group consisting of pentaerythritol tetrakis(3-mercaptopropionate), pentaerythritol tetrakis(thioglycolate), tris(3-mercaptopropionate) trimethylolpropane, tris(mercaptoacetate) trimethylolpropane and compounds of formulae (II) and (III):

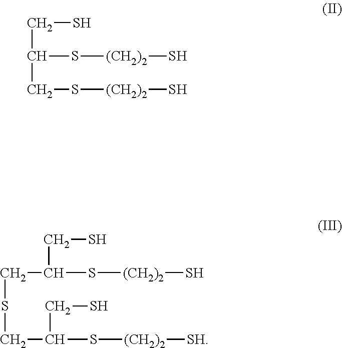

33. The method of claim 16, wherein said polyisocyanate or polyisothiocyanate monomer is a compound of formula (VI): 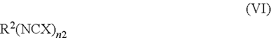
wherein X represents O or S, n2 represents an integer ranging from 2 to 6 and R² represents an aliphatic, alicyclic, heterocyclic or aromatic group.

34. The method of claim 16, wherein said polyisocyanate or polyisothiocyanate monomer is selected from the group consisting of toluene-2,4-diisocyanate, toluene-2,6-diisocyanate, diphenylmethane-4,4′-diisocyanate, diphenylmethane-2,4′-diisocyanate, paraphenylene diisocyanate, xylylene diisocyanate, biphenyl-diisocyanate, 3,3′-dimethyl-4,4′-diphenylene diisocyanate, tetramethylene-1,4-diisocyanate, hexamethylene-1,6-diisocyanate, 2,2,4-trimethyl hexane-1,6-diisocyanate, lysine methyl ester diisocyanate, bis(isocyanatoethyl) fumarate, isophorone diisocyanate, ethylene diisocyanate, dodecane-1,12-diisocyanate, cyclobutane-1,3-diisocyanate, cyclohexane-1,3-diisocyanate, cyclohexane-1,4-diisocyanate, methylcyclohexyl diisocyanate, hexahydrotoluene-2,4-diisocyanate, tetramethylxylylene diisocyanate, hexahydrotoluene-2,6-diisocyanate, hexahydrophenylene-1,3-diisocyanate, hexahydrophenylene-1,4-diisocyanate, perhydro diphenylmethane-2,4′-diisocyanate, 4,4′-dicyclohexylmethanediisocyanate, bis(isocyanatomethyl)cyclohexane, dicyclohexylmethane diisocyanate, 2,5-bis(isocyanatomethyl)bicyclo-[2.2.1]-heptane and 2,6-bis(isocyanatomethyl)bicyclo-[2.2.1]-heptane.

35. The method of claim 16, comprising the following steps 1), 2), 3), 4) and 5) or 1′), 2′), 3′), 4′) and 5′):
1) providing a first component A comprising at least one polyisocyanate or polyisothiocyanate monomer A2,
2) providing a second component B comprising a polythiourethane pre-polymer B1 having thiol end groups, said pre-polymer B1 having been prepared from at least one polythiol monomer and at least one polyisocyanate or polyisothiocyanate monomer,
3) mixing together first and second components A and B and filling a molding cavity of a casting mold assembly with the resulting polymerizable mixture,
4) curing said polymerizable mixture to obtain a polythiourethane based transparent substrate, and
5) recovering the polythiourethane based transparent substrate from the casting mold assembly,
wherein curing step 4) is carried out in the presence of at least one salt catalyst in an amount ranging from 0.0595% to 0.15% by weight with respect to the total weight of polymerizable compounds present in the mixture of first and second components A and B,
or:
1′) providing a first component A comprising a polythiourethane pre-polymer A1 having isocyanate or isothiocyanate end groups of formula —NCX where X is O or S, said pre-polymer A1 having been prepared from at least one polythiol monomer and at least one polyisocyanate or polyisothiocyanate monomer,
2′) providing a second component B comprising at least one polythiol monomer B2,
3′) mixing together first and second components A and B and filling a molding cavity of a casting mold assembly with the resulting polymerizable mixture,
4′) curing said polymerizable mixture to obtain a polythiourethane based transparent substrate, and
5′) recovering the polythiourethane based transparent substrate from the casting mold assembly,
wherein curing step 4′) is carried out in the presence of at least one salt catalyst in an amount ranging from 0.015% to 0.15% by weight with respect to the total weight of polymerizable compounds present in the mixture of first and second components A and B.
